(19) United States
(12) Patent Application Publication
(10) Pub. No.: US 2012/0131520 A1
(43) Pub. Date: May 24, 2012

(54) Gesture-based Text Identification and Selection in Images

(76) Inventors: Ding-Yuan Tang, Pleasanton, CA (US); Joey G. Budelli, Gilroy, CA (US)

(21) Appl. No.: 13/361,713

(22) Filed: Jan. 30, 2012

Related U.S. Application Data
(63) Continuation-in-part of application No. 12/466,333, filed on May 14, 2009.
Application No. 12/466,333 is a continuation-in-part of application No. 12/467,245, filed on May 15, 2009.

(51) Int. Cl. G06F 3/033; G06K 9/18

(52) U.S. Cl. 715/863; 382/182

(57) ABSTRACT

A device with a touch-sensitive screen supports tapping gestures for identifying, selecting or working with initially unrecognized text. A single tap gesture can cause a portion of a character string to be selected. A double tap gesture can cause the entire character string to be selected. A tap and hold gesture can cause the device to enter a cursor mode wherein a placement of a cursor relative to the characters in a character string can be adjusted. In a text selection mode, a finger can be used to move the cursor from a cursor start position to a cursor end position and to select text between the positions. Selected or identified text can populate fields, control the device, etc. Recognition of text can be performed upon access of an image or upon the device detecting a tapping gesture in association with display of the image on the screen.

### CROSS-REFERENCE TO RELATED APPLICATIONS

For purposes of the USPTO extra-statutory requirements, the present application constitutes a continuation-in-part of U.S. patent application Ser. No. 12/466,333 that was filed on 14 May 2009, which is currently co-pending, or is an application of which a currently co-pending application is entitled to the benefit of the filing date.

The present application also constitutes a continuation-in-part of U.S. patent application Ser. No. 12/467,245 that was filed on 15 May 2009, which is currently co-pending, or is an application of which a currently co-pending application is entitled to the benefit of the filing date.

The United States Patent Office (USPTO) has published a notice effectively stating that the USPTO's computer programs require that patent applicants reference both a serial number and indicate whether an application is a continuation or continuation-in-part. See Stephen G. Kunin, Benefit of Prior-Filed Application, USPTO Official Gazette 18 Mar. 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND

1. Field

Embodiments relate to optical character and text recognition and finger tapping gestures in working with text in images.

2. Related Art

Various types of input devices perform operations in association with electronic devices such as mobile phones, tablets, scanners, personal computers, copiers, etc. Exemplary operations include moving a cursor and making selections on a display screen, paging, scrolling, panning, zooming, etc. Input devices include, for example, buttons, switches, keyboards, mice, trackballs, pointing sticks, joy sticks, touch surfaces (including touch pads and touch screens), etc.

Recently, integration of touch screens with electronic devices has provided tremendous flexibility for developers to emulate a wide range of functions (including the displaying of information) that can be performed by touching the screen. This is especially evident when dealing with small-form electronic devices (e.g., mobile phones, personal data assistants, tablets, netbooks, portable media players) and large electronic devices embedded with a small touch panel (e.g., multi-function printer/copiers and digital scanners).

Existing emulation techniques based on gestures are not effective and are unavailable with activities and operations of existing devices, software and user interfaces. Further, it is difficult to select and manipulate text-based information shown on a screen using gestures, especially where the information is displayed in the form of an image. For example, operations such as selecting a correct letter, word, line, or sentence to be deleted, copied, inserted, or replaced often proves difficult or impossible using gestures.

### SUMMARY

Embodiments disclose a device with a touch sensitive screen that supports receiving input such as through tapping and other touch gestures. The device can identify, select or work with initially unrecognized text. Unrecognized text may be found in existing images or images dynamically displayed on the screen (such as through showing images captured by a camera lens in combination with video or photography software). Text is recognized and may be subsequently selected and/or processed.

A single tap gesture can cause a portion of a character string to be selected. A double tap gesture can cause the entire character string to be selected. A tap and hold gesture can cause the device to enter a cursor mode wherein a placement of a cursor relative to the characters in a character string can be adjusted. In a text selection mode, a finger can be used to move the cursor from a cursor start position to a cursor end position and to select text between the positions.

Selected or identified text can populate fields, control the device, etc. Recognition of text (e.g., through one or more optical character recognition functions) can be performed upon access to or capture of an image. Alternatively, recognition of text can be performed in response to the device detecting a tapping or other touch gesture on the touch sensitive screen of the device. Tapping is preferably on or near a portion of text that a user seeks to identify or recognize, and acquire, save, or process.

Other details and features will be apparent from the detailed description.

### BRIEF DESCRIPTION OF THE DRAWINGS

FIG. 1 illustrates a “single tap” gesture to select a word of text, in accordance with one embodiment.

FIG. 2 illustrates a “double tap” gesture to select a line of text, in accordance with one embodiment.

FIG. 3 illustrates a “tap and hold” gesture to select a portion of a line of text, in accordance with one embodiment.

FIG. 4 illustrates operations in cursor mode, in accordance with one embodiment.

FIG. 5 illustrates operations in text selection mode, in accordance with one embodiment.

FIG. 6 shows a scanner coupled to a document management system, in accordance with one embodiment.

FIG. 7 shows a flowchart for selecting or identifying text using the gestures, in accordance with various embodiments.

FIG. 8 shows a user interface of a touch screen, in accordance with one embodiment.

FIG. 9 shows a diagram of an exemplary system on which to practice the techniques described herein.

FIG. 10 shows an exemplary scenario of identifying and recognizing text, and performing a function or action with the recognized text.

FIG. 11 shows another exemplary scenario of identifying and recognizing text, and performing a function or action with the recognized text.

FIGS. 12-14 show flowcharts of steps of exemplary methods by which to implement the techniques described herein.

### DETAILED DESCRIPTION

In the following description, for purposes of explanation, numerous specific details are set forth. Other embodiments and implementations are possible.

Reference in this specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, a technique described herein is to select or identify text based on gestures. The technique may be implemented on any electronic device with a touch interface to support gestures, or on devices that accept input or feedback from a user, or on devices through automated selection means (e.g., software or firmware algorithms). Advantageously, in one embodiment, once text is selected or identified, further processing is initiated based on the selected or identified text, as further explained.

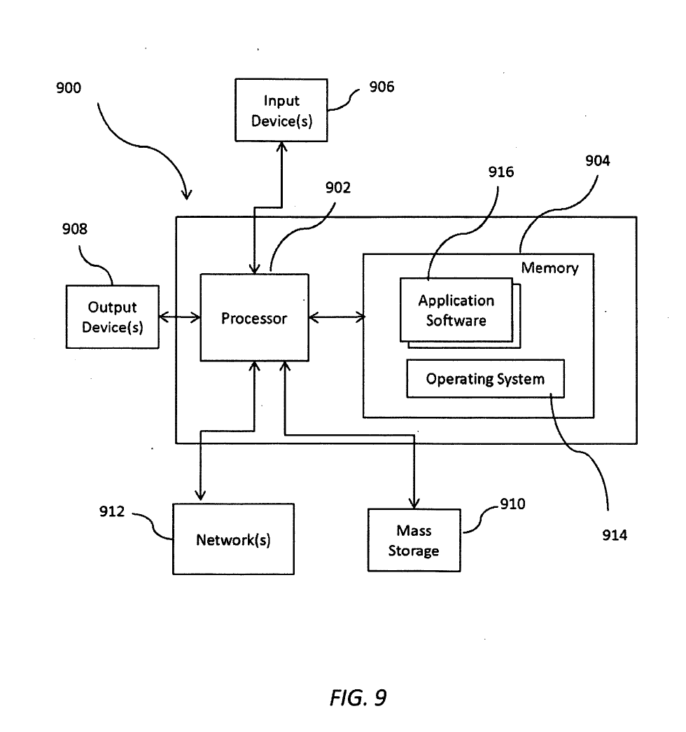

While the category of electronic devices with a touch interface to support gestures is quite large, for illustrative purposes, reference is made to a multi-function printer/copier or scanner equipped with a touch sensitive screen. Hardware for such a device is described with reference to FIG. 9. Reference may also be made to a generic touch sensitive screen.

In one embodiment, a tapping gesture is used for text selection or identification. The type of tapping gesture determines how text gets selected or how a portion of text is identified.

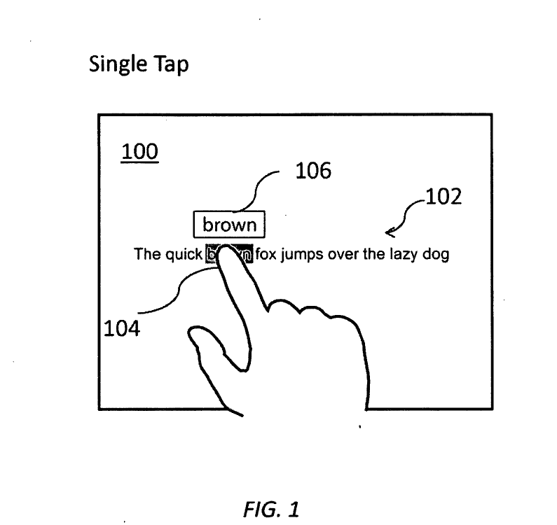

FIG. 1 of the drawings illustrates text selection with a type of tapping gesture known as a “single tap”. Referring to FIG. 1, a touch screen 100 displays the sentence 102, “the quick brown fox jumps over the lazy dog”. Single tapping of the word brown by a finger 104 causes selection or identification of the word “brown”, as illustrated in FIG. 1. Advantageously, the selected word is displayed in a window 106 that may be laterally offset relative to the sentence 102 to enhance readability. Thus, with the “single tap” gesture, a single tap with a finger on, near or over the word desired to be selected or identified, causes selection or identification of that word. The selection or identification occurs in the region under or near the point of contact with the touch screen 100 of the single tap gesture.

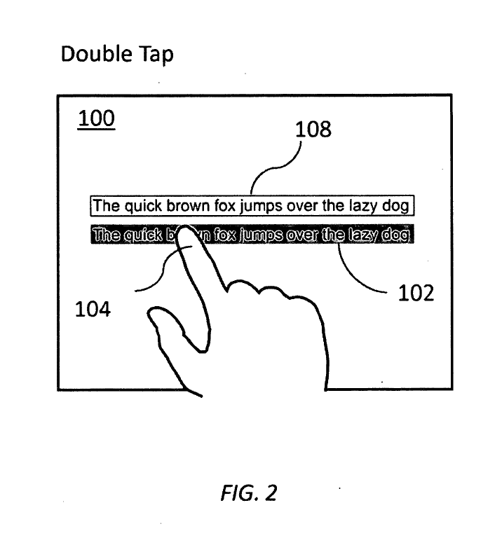

FIG. 2 of the drawings illustrates text selection using a gesture referred to as “double tap”. FIG. 2 shows the same sentence 102 as shown in FIG. 1. With the “double tap” gesture, a user double taps the touch screen 100 at any point where the sentence 102 is displayed—on or near the text. A double tap is a sequence of taps in succession that the touch screen 100 or computing device interprets as, effectively, a single gesture. The double tap gesture causes the entire sentence 102 to be selected as text and can be displayed in a laterally offset window 108.

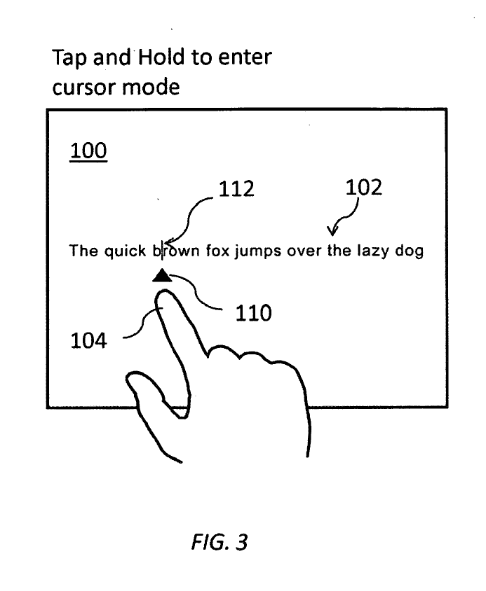

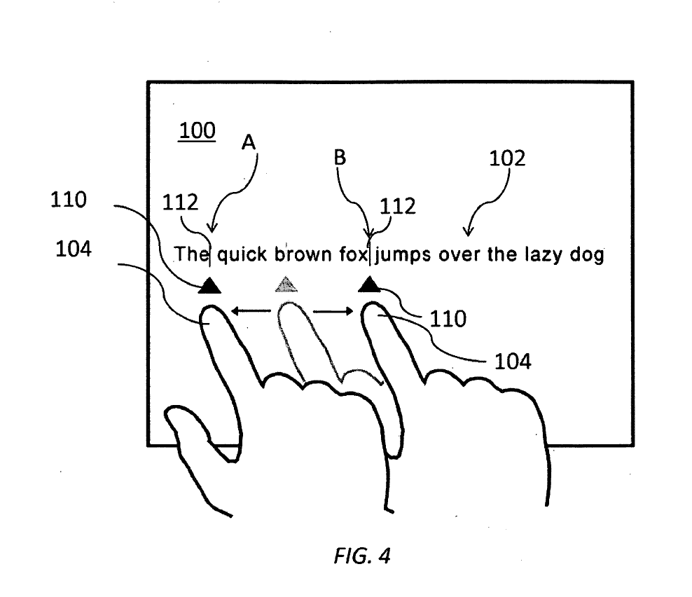

FIG. 3 of the drawings illustrates a gesture known as “tap and hold”. The “tap and hold” gesture is used to select a portion of a line of text, as will now be described. With the “tap and hold” gesture, a user (e.g., finger 104, stylus) touches the touch screen 100 adjacent or near to the first character in the sentence 102 from which text selection is to begin. Maintaining finger contact on the touch screen 100 causes the device (touch screen 100) to transition to a cursor mode. As shown in FIG. 3, a finger 104 is placed adjacent letters “b” and “r” of the word brown. Maintaining finger contact with the touch screen 100 without releasing the finger causes a cursor control 110 to appear adjacent (e.g., before, inside, underneath) the word brown. Further, a cursor 112 is placed between the letters “b”, and “r”, as is shown and as detected in response to a touch at or near a location between letters b and r. The device is now in cursor mode and the user can slide his finger 104 to the left or to the right a certain number of characters in order to move the position of the cursor 112 (and cursor control 110) to facilitate or engage text selection as further described with reference to FIG. 4.

Referring to FIG. 4, a finger 104 may be used to perform the described tap and hold gesture on the touch screen 100 at a location at or adjacent the position indicated by reference character “A”. When recognized by the device, this gesture causes the cursor 112 to appear immediately to the right of the word, “The”. This state is considered cursor mode: the cursor 112 and/or cursor control 110 is activated in the text 102. If the user is content with such position of the cursor 112, the user releases contact of the finger 104 with the touch screen 100. As a result, the device is placed in a text selection mode. In text selection mode, the finger 104 can re-contact the touch screen 100 and can be slid across the touch screen 100 to the left or right of the current cursor position “A” to cause selection of text beginning at the current cursor position “A”.

If the user is not content with the initial cursor position “A”, the user does not release the finger 104 and does not enter text selection mode as described. Instead, the user maintains finger contact on the touch screen 100 to cause the device to continue being in cursor mode. In cursor mode, the user can slide the finger 104 to move the cursor 112 and/or cursor control 110 to a desired location in the text 102. Typically, movement of the cursor control 110 causes a sympathetic or corresponding movement in the position of the cursor 112. In the example of FIG. 4, the finger 104 is slid to the right in order to move the cursor 112 and cursor control 110 to the right from their initial position at “A”. Moving the cursor control 110 to the right causes the cursor 112 to be sympathetically moved. When the cursor 112 has thus been moved to a desired position on the touch screen 100, the finger 104 is released and the device enters a text selection mode with the cursor 112 in the desired position to begin text selection. In the example of FIG. 4, a final or desired cursor position is immediately to the right of the word “fox”—shown as position “B”.

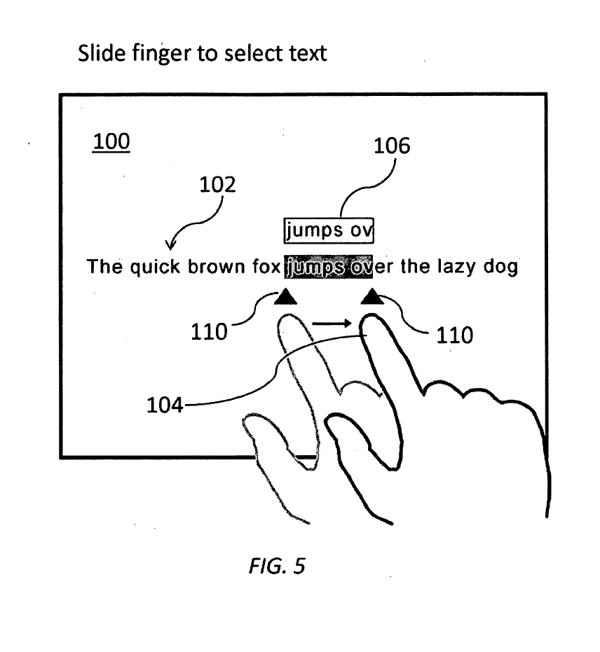

Text selection in text selection mode is illustrated with reference to FIG. 5. In text selection mode, the cursor 112 can be moved using the cursor control 110 as in cursor mode except that any text (e.g., letters, numbers, spaces, special characters, punctuation) between the cursor start position and cursor end position is selected. In the example of FIG. 4, the finger 104 is slid to the right to move the cursor 112 from its start position immediately to the right of the word “fox” to a location between the letters “o” and “v” of the word “over. This causes the string “jumps ov” to be selected or identified and, optionally, placed in a window 106. The window 106 may be of an enlarged size or reduced size, or the text in the window 106 may be of a different font so as to facilitate faster or easier recognition of the selected or identified text.

The above-described gesture-based methods may advantageously be implemented on a scanner to capture information from scanned documents. Alternatively, such gesture-based methods may be implemented on touch-enabled display such as on a smartphone, a tablet device, a laptop having a touch screen, etc.

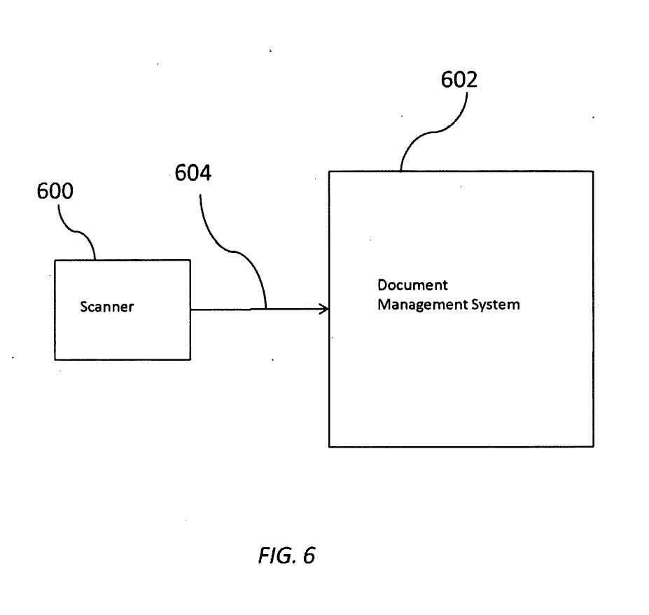

With reference to FIG. 6, a scanner 600 may be coupled to a document management system 602 via a communications path 604. The scanner 600 is equipped with a touch-sensitive screen 100 to display at least portions of a scanned document to an operator. Further, the scanner 600 supports the above-described gestures. The document management system may be located on-site or off-site. In one embodiment, the communications path 604 may operate by any methods and protocols such as those operable over the Internet.

In some embodiments, a touch screen 100 may display an image comprising text that has not previously been subjected to optical character recognition (OCR). In such cases, an OCR operation is performed as described herein more fully. In summary, the OCR operation may be performed immediately after the device accesses, opens or captures the image or displays the image. Alternatively, the OCR operation may be performed over a portion of the image as a user interacts with the (unrecognized) image displayed on the touch screen 100.

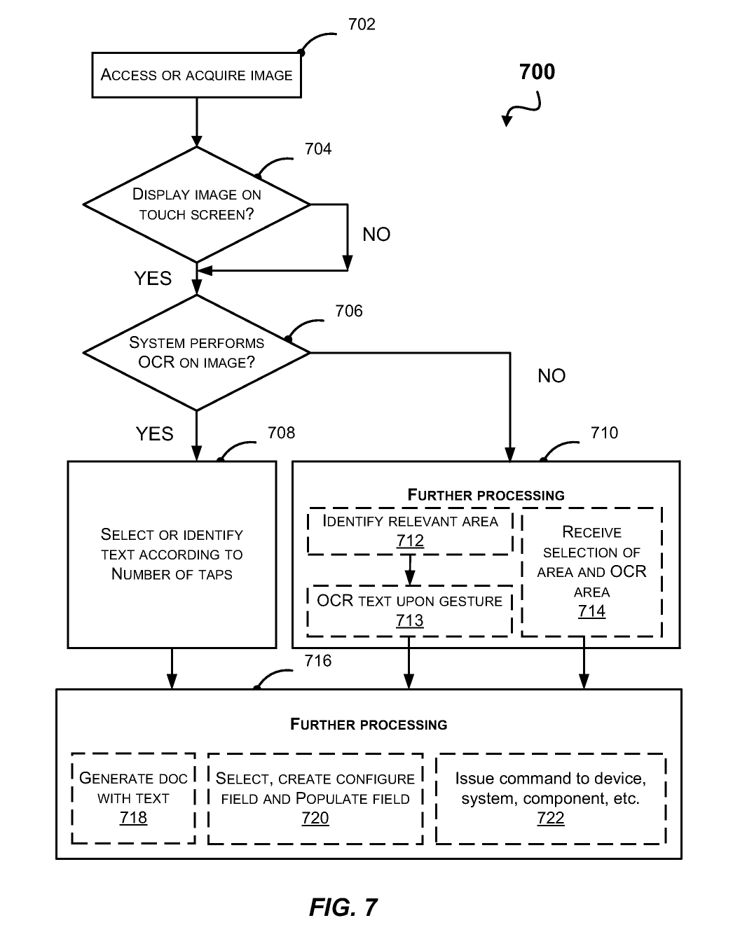

The OCR operation may be performed according to or part of one of various scenarios, some of which are illustrated in the flowchart 700 of FIG. 7. Referring to FIG. 7, at block 702, a user or operator actuates a device to access or acquire an image. For example, a user may use a copier/scanner to scan a page of a document, use a smartphone to take a picture of a receipt, or download an image from a network accessible storage or other location. At block 704, the device (e.g., scanner, smartphone, tablet) with a touch screen may or may not display a representation of the image at this point in the scenario. At block 706, the device or a portion of a system may perform an OCR operation or series of OCR operations on the image, or not.

In one embodiment, if an OCR operation is performed, the device (e.g., tablet, smartphone) identifies a relevant portion of the image that likely has text, and performs OCR on the entire portion of the image with text or the entire image. This scenario involves segmenting the image into regions that likely have text and performs recognition of each of these regions—characters, words and/or paragraphs (regions) are located, and characters, words, etc. are recognized. This scenario occurs at step 706 when OCR is performed.

Alternatively, the capture portion of a device may send the image (or portion of the image) to a component of the system, and the component of the system may perform one or more OCR functions and returns the result to the device. For example, a smartphone could capture an image and could send the image to a network accessible computing component or device, and the computing component or device (e.g., server or cloud-based service) would OCR the image and return a representation of the image and/or the recognized text back to the smartphone.

Assuming that the system or device performed OCR function(s) on the image, at block 708, a user selects or identifies text on a representation of the image shown on the touch screen of the device by making a tapping or touch gesture to the touch screen of the device. The portion of text so selected or identified optionally could be highlighted or otherwise displayed in a way to show that the text was selected or identified. The highlighting or indication of selection could be shown until a further action is triggered, or the highlighting or indication of selection could be displayed for s short time, such as a temporary flashing of text selected, touched or indicated. Such highlighting could be done by any method known in the user interface programming art. After text is selected, at block 716, further processing maybe performed with the selected or identified text (as explained further below). Preferably, such further processing occurs in consequence of selecting or identifying the text (at 708) such that further processing occurs directly after said selecting or identifying.

From block 706, when the system does not perform OCR on the entire image (initially), further processing is done at block 710. The further processing at block 710 includes, for example, allowing a user to identify a relevant portion or area of the image by issuing a tap or touch gesture to the touch screen of the device as shown in block 712. For example, a user could make a single tap gesture on or near a single word. In response to receiving the gesture, the device estimates an area of interest, identifies the relevant region containing or including the text (e.g., word, sentence, paragraph), performs one or more OCR functions, and recognizes the text corresponding to the gesture at block 713. The OCR of the text 713 preferably occurs in response to or directly after identifying a relevant portion of text or area of text.

Alternatively, the further processing of block 710 could be receiving an indication of an area that includes text as shown at block 714. When a user selects an entire area, such as by communicating a rectangle gesture to the touch screen (and corresponding portion of the image), the device or part of the system performs OCR on the entire selected area of the image. For example, a user could select a column of text or a paragraph of text from an image of a page of a document.

Once text is selected, yet further processing may be performed at block 716. For example, a document (or email message, SMS text message, or other “document”-like implementation) may be populated or generated with some or all of the recognized text. Such document may be automatically generated in response to the device receiving a tapping gesture at block 708. For example, if a user takes a picture of text that includes an email address, and then makes a double-tap gesture on or near the email address, the system may find the relevant area of the image, OCR (recognize) the text corresponding to the email address, recognize the text as an email address, open an application corresponding to an email message, and populates a “to” field with the email address. Such sequence of events may occur even farther upstream in the process, such as at the point of triggering a smartphone to take a picture of text that includes an email address. Thus, an email application may be opened and pre-populated with the email address from the picture in response to just taking a picture. The same could be done with a phone number: a picture could be taken, and the phone number would be dialed or stored into a contact. No intermediate encoding of text, such as through use of a QR code, need be used due in part to OCR processing.

The techniques described may be used with many file types (images). For example image file types (e.g., .tiff, .jpg, and .png file types) may be used. Further, vector-based images may be used and do not have encoded text present. PDF format documents may or may not have text already encoded and available. At the time of opening a PDF document, a device using the techniques described herein can determine whether the document has encoded text information available or not, and can determine whether OCR is needed.

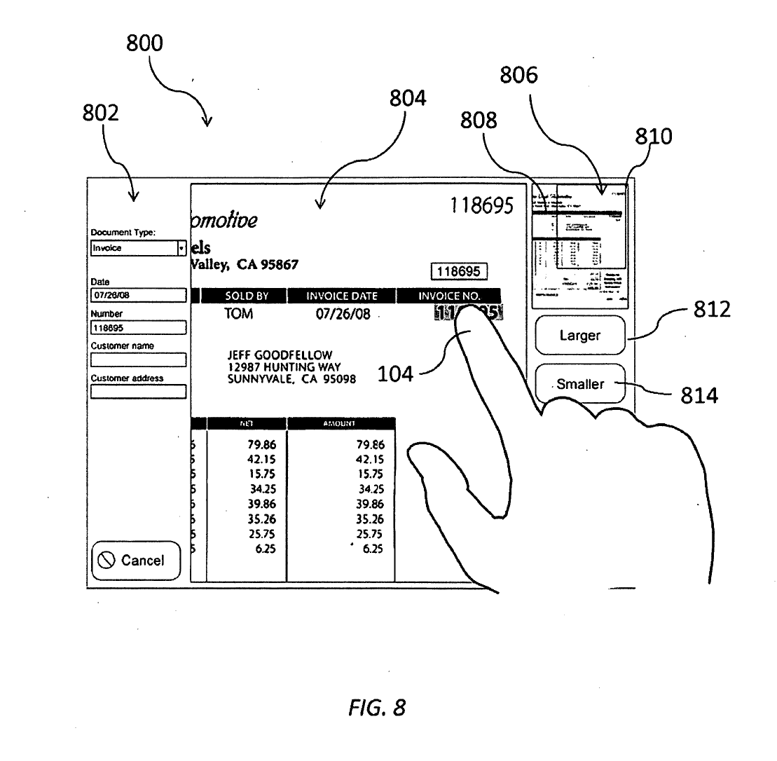

FIG. 8 shows an exemplary scenario and embodiment. With reference to FIG. 8, a user interface 800 is presented on a touch screen 100 for a user or an operator. The interface 800 includes a left panel 802, a middle panel 804 and a right panel 806. The right panel 806 displays a representation of a scanned image 808 such as an invoice. A zoom frame 810 shows the portion of the scanned image 808 that is currently displayed in the middle panel 804. A button 812 increases the zoom of the window 810 when actuated, and a button 814 decreases the zoom when actuated.

The described tapping gestures are preferably performed on the middle panel 804 to select text. As shown in FIG. 8, a finger 104 may be used to select or identify text corresponding to an invoice number. Using, for example, through the single tap gesture described above, an invoice number is identified or selected and is copied to or caused to populate a selected or activated (active) field in the left panel 802. The fields of the left panel 804 may be designated or configured at any time—e.g., before or during interaction with the image (invoice). The fields and the data populating the fields are to be used or associated with the particular invoice shown in the middle panel 804. In FIG. 8, the fields for an “invoice” Document Type are, for example, Date, Number, Customer name and Customer address. A user may add, remove, modify, etc. these fields. A user may select a different Document Type through a user interface control such as the one shown in FIG. 8. A different Document Type would likely have a different set of fields associated with it. A user may cancel out of the data extraction mode by selecting, for example, a “Cancel” button as shown in the left panel 802.

Each time a user selects, identifies or interacts with the text in the middle panel 804, the user interface and software operating on the device may automatically determine the format of the text so selected. For example, if a user selects text that is a date, the OCR function determines or recognizes that the text is a date and populates the field with a date. The date extracted from the format associated with a “date” field in the left panel 802 may be used to format the text selected or extracted from the middle panel 804. In FIG. 8, the date is of the form, “MM/DD/YY”. The format of the “Invoice Date” happened to be of the same format as the field in the left panel 802. However, such situation is not required. If the Invoice Date in the center panel 804 was “26 Jul. 2008” and a user selected this text, the user interface could have modified the format and populated the Date field in the left panel 802 with “Jul. 26, 2008.” Similar functionality—through the OCR functions—is preferably implemented for such text as times, addresses, phone numbers, email addresses, Web addresses, currency, ZIP codes, etc.

Similarly, fonts and other text attributes may be modified consistent with a configuration for each data field in the left panel 802 as the text is identified or selected, and sent to the respective field. Thus, the font, text size, etc. of the text found or identified in the image of the center panel 804 is not required to be perpetuated to the fields in the left panel 802, but may be done. In such case, the user interface attempts to match the attributes of the recognized text of the image with a device-accessible, device-generated, or device-specific font, etc. For example, the Invoice Number from the image may correspond to an Arial font or typeface of size 14 of a font generated by the operating system of a smartphone. With reference to FIG. 8, such attributes could be carried over with the text “118695” to the Number field.

With reference to FIG. 8, once a user is finished populating the fields from the invoice, a user may store, send, or further process the text (data) extracted from the invoice. Further processing may include sending the data to a network accessible location or database, synchronizing the data with an invoice processing function (e.g., accounting system), sending the data via email or SMS text message, saving the information to a hard disk or memory, etc. Data extracted in the above-described manner(s) can also use metadata associated with the scanned document or to populate a form/document that can be sent to the document management system 602 for storage and/or further processing.

FIG. 9 shows an example of a scanner that is representative of a system 900 with a touch-sensitive screen to implement the described gesture-based text selection or identification techniques. The system 900 includes at least one processor 902 coupled to at least one memory 904. The processor 902 shown in FIG. 9 represents one or more processors (e.g., microprocessors), and the memory 904 represents random access memory (RAM) devices comprising a main storage of the system 900, as well as any supplemental levels of memory e.g., cache memories, non-volatile or back-up memories (e.g. programmable, flash memories), read-only memories, etc. In addition, the memory 904 may be considered to include memory storage physically located elsewhere in the system 900, e.g., any cache memory in the processor 902 as well as any storage capacity used as a virtual memory, e.g., as stored on a mass storage device 910.

The system 900 also may receive a number of inputs and outputs for communicating information externally. For interface with a user or operator, the system 900 may include one or more user input devices 906 (e.g., keyboard, mouse, imaging device, touch-sensitive display screen) and one or more output devices 908 (e.g., Liquid Crystal Display (LCD) panel, sound playback device (speaker, etc)).

For additional storage, the system 900 may also include one or more mass storage devices 910 (e.g., removable disk drive, hard disk drive, Direct Access Storage Device (DASD), optical drive (e.g., Compact Disk (CD) drive, Digital Versatile Disk (DVD) drive), tape drive). Further, the system 900 may include an interface with one or more networks 912 (e.g., local area network (LAN), wide area network (WAN), wireless network, Internet) to permit the communication of information with other computers coupled to the one or more networks. It should be appreciated that the system 900 may include suitable analog and digital interfaces between the processor 902 and each of the components 904, 906, 908, and 912 as may be known in the art.

The system 900 operates under the control of an operating system 914, and executes various computer software applications, components, programs, objects, modules, etc., to implement the techniques described. Moreover, various applications, components, programs, objects, etc., collectively indicated by Application Software 916 in FIG. 9, may also execute on one or more processors in another computer coupled to the system 900 via network(s) 912, e.g., in a distributed computing environment, whereby the processing required to implement the functions of a computer program may be allocated to multiple computers over the network(s) 912. Application software 916 may include a set of instructions which, when executed by the processor 902, causes the system 900 to implement the methods described.

The routines executed to implement the embodiments may be implemented as part of an operating system or a specific application, component, program, object, module or sequence of instructions referred to as computer programs. The computer programs may comprise one or more instructions set at various times in various memory and storage devices in a computer, and that, when read and executed by one or more processors in a system, cause the system to perform operations necessary to execute elements involving the various aspects.

While the techniques have been described in the context of fully functioning computers and computer systems, those skilled in the art will appreciate that the various embodiments are capable of being distributed as a program product in a variety of forms, and that the techniques operate regardless of the particular type of computer-readable media used to actually effect its distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

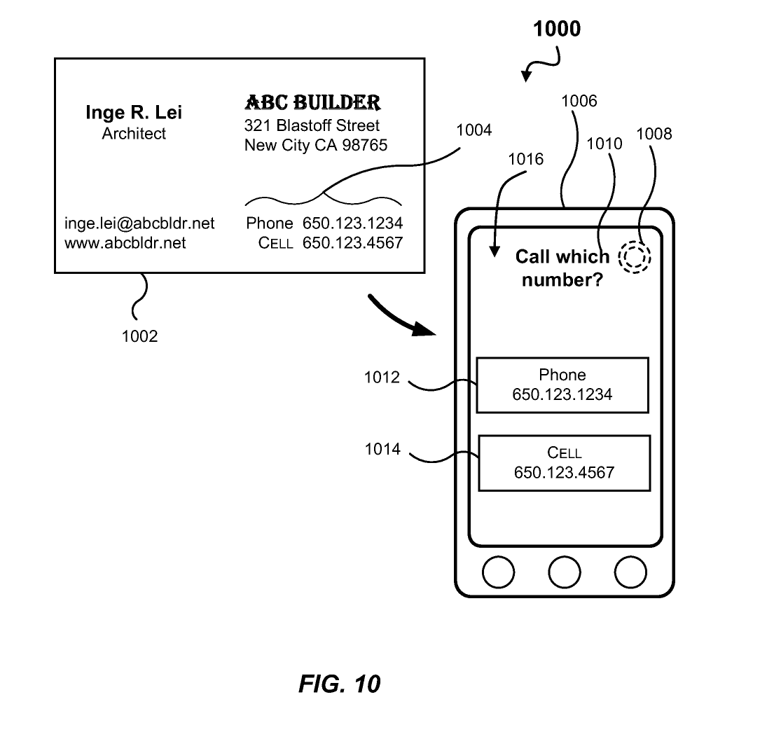

FIG. 10 shows an exemplary scenario 1000 of identifying and recognizing text, and performing a function or action with the recognized text. With reference to FIG. 10, a user (not shown) has a business card 1002 and desires to make a cellular telephone call with one of the phone numbers 1004 printed thereon. The user engages a function on the cellular telephone 1006 which causes the camera 1008 of the cellular telephone 1006 to capture an image of a relevant portion or all of the business card 1002. The user engages this function through, for example, interaction of the touch screen 1016 on the cellular telephone 1006. Subsequently, without further input from the user, the cellular telephone 1006 performs OCR functions on the image, identifies the relevant text that is likely telephone numbers and presents the telephone numbers 1004 on the touch screen 1016 of the cellular telephone 1006. The presentation includes a prompt 1010 for further input from the user such as an offer to initiate a telephone call to either the “phone number” 1012 or the “cell phone” number 1014 printed on the business card 1002. A user would only have to select one of the two regions 1012, 1014 to initiate the telephone call. If there were only a single telephone number in the image (not shown) or on the business card 1002, the cellular telephone 1006 would initiate a telephone call without further input from the user.

Further, the functionality operating on the cellular telephone 1006 may only momentarily, temporarily or in passing capture an image of some or all of the business card. For example, upon engaging the desired function, the cellular telephone 1006 may operate the camera 1008 in a video mode, capture one or more images, and recognize text in these images until the operation and cellular telephone 1006 locates one or more telephone numbers. At that time, the cellular telephone 1006 discards any intermediate or temporary data and any captured video or images, and initiates the telephone call.

Alternatively, the cellular telephone 1006 may be placed into a telephone number capture mode. In such mode, the camera 1008 captures image(s), the cellular telephone 1006 extracts information, and the information is stored in a contact record. In such mode any amount of recognized data may be used to populate fields associated with the contact record such as first name, last name, street address and telephone number(s) (or other information available in an image of some or all of the business card 1002). A prompt confirming correct capture may be shown to the user on the touch screen 1016 prior to storing the contact record.

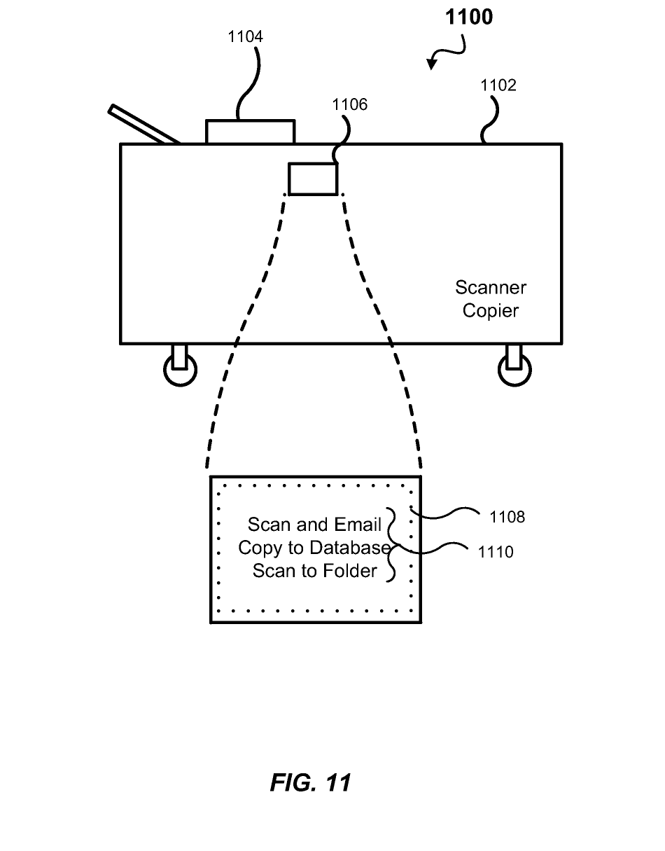

FIG. 11 shows another exemplary scenario 1100 of identifying and recognizing text, and performing a function or action with the recognized text. With reference to FIG. 11, a scanner/copier 1102 may be used to process a document (not shown) in a document feeder 1104. Processing is initiated by interacting through a touch screen 1106 of the scanner/copier 1102. Instead of a traditional, programmed interface, the touch screen 1106 could be populated with an image of text 1108 where the text is the set of available functions for the scanner/copier 1102. For example, when a user desires to cause the scanner/copier 1102 to “scan and email” a document, the user would press a finger to the touch screen 1106 on or near the text “Scan and Email.” In response, the scanner/copier 1102 would identify the relevant portion of the touch screen 1106, identify the relevant string of text, perform OCR functions, and would pass the recognized text to the scanner/copier 1102. In turn, the scanner/copier 1102 would interpret the recognized text and perform one or more corresponding functions (e.g., scan and email).

Alternatively, some or all of a page of the document (not shown) could be shown on the touch screen 1106. A user could select text from the document shown in the image 1108 shown on the touch screen 1106 according to the mechanism(s) described in reference to FIG. 8. By interacting with the touch screen 1106, a user could configure the scanner/copier 1102 to capture certain data from any current or future document passed into the scanner/copier 1102. For example, with reference to FIG. 8 and FIG. 11, the scanner/copier 1102 could be configured to capture each instance of: (1) Date, (2) Number, (3) Customer name and (4) Customer address from a collection of documents passed to or fed to the scanner/copier 1102.

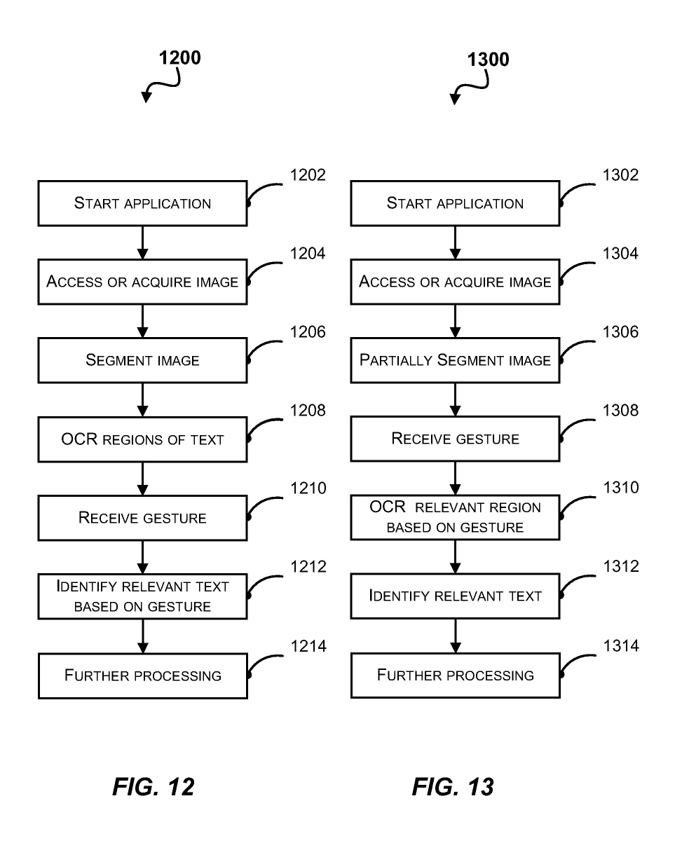

FIG. 12 shows a flowchart of steps of an exemplary method 1200 by which to implement the techniques described herein. With reference to FIG. 12, if not already operating on a device, a device user or other entity starts a software application 1202 programmed with instructions for performing the techniques described herein. Next, an image having text is accessed or acquired 1204. For example, a user of a smartphone opens an existing image from local or remote storage, or a user of a smartphone having a camera takes a photograph of a page of text or composes and takes a picture with a sign having text.

Once an image is accessed or acquired, the software program segments the image into regions 1206. These regions are those that likely contain a group of textual elements (e.g., letters, words, sentences, paragraphs). Such segmentation may include calculating or identifying coordinates, relative to one or more positions in the image, of the textual elements. Such coordinates may be recorded or saved for further processing. Segmenting 1206 may include one or more other functions. After sementing, one or more components perform optical character recognition (OCR) functions on each of the identified regions 1208. The OCR step 1208 may include one or more other related functions such as sharpening of regions of the acquired image, removing noise, etc. The software then waits for input (e.g., gesture, touch by a user) to a touch enabled display on a location of or near one of the segmented text regions. In a preferred implementation, at least a portion of the image, or a representation of the image, is shown on the touch enabled display. The displayed image may serve as a reference for determining where in the image a touch or gesture is given and interpreted. It is through the displayed image that interaction with the text of the image is possible.

In response to receiving an input or gesture 1210, the software interprets the input or gesture and then identifies a relevant text of the image 1212. Such identification may include, for example, selecting the relevant text, saving the relevant text to a memory or storage, copying the text to a memory, or passing a copy of the text to another function or software. Further processing 1214 is preferably performed on the identified text. Further processing 1214 may include such activities as populating a field of a database accessible by the software, dialing a telephone number, sending an SMS text message, launching an email program and populating one or more relevant fields, etc.

FIG. 13 shows a flowchart of steps of an exemplary method 1300 by which to implement the techniques described herein. With reference to FIG. 13, if not already operating on a device, a device user or other entity starts a software application 1302 programmed with instructions for performing the techniques described herein. Next, an image having text is accessed or acquired 1304. For example, a user of a smartphone opens an existing image from local or remote storage, or a user of a smartphone having a camera takes a photograph of a page of text or composes and takes a picture with a sign having text.

Once an image is accessed or acquired, the software program partially segments the image into regions 1306. These regions are those that likely contain a group of textual elements (e.g., letters, words, sentences, paragraphs). Such partial segmentation may include calculating or identifying some possible coordinates, relative to one or more positions in the image, of the textual elements. Such coordinates may be recorded or saved for further processing. Partially segmenting the image 1306 may include one or more other functions. Partial segmentation may identify down to the level of each character, or may segment just down to each word, or just identify those few regions that contain a block of text. As to FIG. 13, partial segmentation preferably does not include the operation of OCR functions.

Instead, at this stage of the exemplary method 1300, the software waits for and receives input (e.g., gesture, touch by a user) to the touch enabled display 1308 on a location of or near one of the segmented text regions. In a preferred implementation, at least a portion of the image, or a representation of the image, is shown on the touch enabled display. The displayed image may serve as a reference for determining where in the image a touch or gesture is given and interpreted. It is through the displayed image that interaction with the text of the image is possible.

In response to receiving the touch or gesture 1308, one or more components perform one or more optical character recognition (OCR) functions 1310 on an identified region that corresponds to the touch or gesture. The OCR step 1310 may include one or more other related functions such as sharpening of a relevant region of the acquired image, removing noise from the relevant region, etc. For example, a block or region of the image (that includes a word of text in bitmap format) “receives” a double-tap gesture and this block or region of the image is subjected to an OCR function through which the word is recognized and identified. Next, the relevant text is identified 1312. Continuing with the double-tap example, such identification involves identifying just a single word from a line of text where the tap gesture has been interpreted to refer to the particular word based on the location of the tap gesture. Identification may also include displaying the word on the touch enabled display or altering the pixels of the image that correspond to the word in the image. At this point, the displayed image or portion of the image is still preferably a bitmapped image, but may include a combination of bitmapped image and rendering to the display of encoded (i.e., recognized) text. The displaying of text may include addition of a highlighting characteristic, or a color change to each letter of the selected word. Such identification may also include, for example, selecting the relevant text, saving the relevant text to a memory or storage, copying the text to a memory, or passing a copy of the text to another function or software. Further processing 1314 is preferably performed on the identified text. Further processing 1314 may include such activities as populating a field of a database accessible by the software, dialing a telephone number, sending an SMS text message, launching an email program and populating one or more relevant fields, etc. The further processing may be dependent upon the interpretation of the recognized text. For example, if the word selected through a tap gesture is “open,” the further processing may involve launching of a function or dialogue for a user to open a document. In another example, if the word selected through a tap gesture is “send,” further processing may involve communicating to the instant or other software application to receive the command to “send.” In yet another example, if the text selected through a tap gesture is “call 650-123-4567”, further processing may involve causing the device to call the recognized phone number.

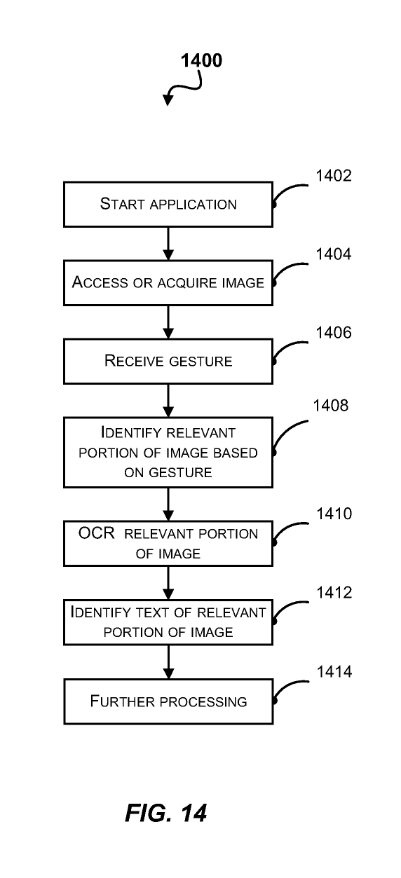

FIG. 14 shows a flowchart of steps of yet another exemplary method 1400 by which to implement the techniques described herein. With reference to FIG. 14, if not already operating on a device, a device user or other entity (e.g., automation, software, operating system, hardware) starts a software application 1402 programmed with instructions for performing the techniques described herein. Next, an image having text is accessed or acquired 1404. For example, a user of a smartphone opens an existing image from local or remote storage, or a user of a smartphone having a camera takes a photograph of a page of text or composes and takes a picture with a sign having text. Alternatively, a scanner could acquire an image from a paper document.

At this stage of the exemplary method 1400, the software waits for and receives input (e.g., gesture, touch by a user) to the touch enabled display 1406 on a location of or near one of the segmented text regions. In a preferred implementation, at least a portion of the image, or a representation of the image, is shown on the touch enabled display when waiting for the input, gesture or touch. The displayed image may serve as a reference for determining where in the image a touch or gesture is given and interpreted. It is through the displayed image that interaction with the text of the image is possible.

In response to receiving the touch or gesture 1406, one or more components perform identification 1408 (such as a segmentation or a location identification) on a relevant portion (or entirety) of the image. Further, one or more components perform one or more OCR functions 1410 on an identified region that corresponds to the touch or gesture. The segmentation step 1408 or OCR step 1410 may include one or more other related functions such as sharpening of a relevant region of the acquired image, removing noise from the relevant region, etc. For example, a block or region of the image (that includes a word of text in bitmap format) “receives” a double-tap gesture and this block or region of the image is subjected to segmentation to identify a relevant region, and then to an OCR function through which the word is recognized and identified. Segmentation and OCR of the entire image need not be performed through this method 1400 if the gesture communicates less than such. Accordingly, less computation by a processor is needed for a user to gain access to recognized (OCR'd) text of an image through this method 1400.

Next, the text of a relevant portion of the image is identified 1412. Continuing with the double-tap example, such identification involves identifying just a single word from a line of text where the tap gesture has been interpreted to refer to the particular word based on the location of the tap gesture. Identification may also include displaying the word on the touch enabled display or altering the pixels of the image that correspond to the word in the image. At this point, the displayed image or portion of the image is still preferably a bitmapped image, but may include a combination of bitmapped image and rendering to the display of encoded (i.e., recognized) text. The displaying of text may include addition of a highlighting characteristic, or a color change to each letter of the selected word. Such identification may also include, for example, selecting the relevant text, saving the relevant text to a memory or storage, copying the text to a memory, or passing a copy of the text to another function or software. Further processing 1314 is preferably performed on the identified text. Further processing 1314 may include such activities as populating a field of a database accessible by the software, dialing a telephone number, sending an SMS text message, launching an email program and populating one or more relevant fields, etc.

While certain exemplary embodiments have been described and shown in the accompanying drawings, it is to be understood that such embodiments are merely illustrative and not restrictive and that the techniques are not limited to the specific constructions and arrangements shown and described, since various other modifications may occur to those ordinarily skilled in the art upon studying this disclosure. In this technology, where growth is fast and further advancements are not easily foreseen, the disclosed embodiments may be readily modifiable in arrangement and detail as facilitated by enabling technological advancements without departing from the principals of the present disclosure.

We claim:

1. A method comprising:
acquiring an image of text;
performing an identification function by a processor on the image of text;
displaying a representation of at least a portion of the acquired image of text on a touch-sensitive screen;
detecting a finger tapping gesture on the touch-sensitive screen on or adjacent a location of a portion of text of the image of text;
identifying characters based at least in part on the detected finger tapping gesture; and
performing a further processing based at least in part on the identified characters.

2. The method of claim 1 wherein said performing the further processing based at least in part on the identified characters includes performing processing based at least in part on the detected identified finger tapping gesture.

3. The method of claim 1 wherein the identification function includes one or more optical character recognition (OCR) functions performed on the text of the image of text.

4. The method of claim 1 wherein said identifying characters based at least in part on the detected finger tapping gesture includes:
performing one or more optical character recognition (OCR) functions on text in at least a portion of the image of text.

5. The method of claim 1 wherein said performing an identification function by a processor on the image of text includes:
identifying one or more regions of the image of text that likely include text.

6. The method of claim 1 wherein said performing the identification function by the processor on the image of text includes:
performing a recognition function to identify characters in the image of text.

7. The method of claim 6 wherein the recognition function to identify characters in the image of text recognizes groups of characters.

8. The method of claim 1 wherein said performing the identification function by the processor on the image of text is performed prior to the touch-sensitive screen being capable of interpreting a finger tapping gesture associated with said image of text.

9. The method of claim 1 wherein the method further comprises:
performing an optical character recognition (OCR) operation of text in the displayed representation of the at least portion of the acquired image of text on the touch-sensitive screen.

10. The method of claim 1 wherein said further processing based at least in part on the identified characters includes performing a processing based at least in part upon the meaning of one or more words of the identified characters.
detecting a finger tapping gesture on the touch-sensitive screen on or adjacent a location of a portion of text of the image of text;

11. The method of claim 1, wherein the finger tapping gesture comprises a single tap gesture, and wherein said identifying characters based at least in part on the detected finger tapping gesture includes:
selecting a word from a line of text of the representation of the at least the portion of the acquired image of text displayed on the touch-sensitive screen based on a proximity of the single tap gesture to the word in the line of the identified characters.

12. The method of claim 11, wherein said selecting the word from the line of text further comprises:
displaying the recognized text in a text box that is laterally offset from a line of recognized text.

13. The method of claim 1, wherein the finger tapping gesture comprises a double tap gesture, and wherein said identifying characters based at least in part on the detected finger tapping gesture includes:
selecting a line of characters based on a proximity of the double tap gesture to the line of the identified characters.

14. The method of claim 1, wherein the finger tapping gesture comprises a tap and hold gesture wherein a tap to the touch-sensitive screen includes maintaining contact with said touch-sensitive screen.

15. The method of claim 14, wherein the method further comprises:
responsive to said tap and hold gesture, entering a cursor mode in which maintaining contact with the touch-sensitive screen includes sliding a distance on said touch-sensitive screen, and wherein said sliding causes sympathetic movement of a cursor.

16. The method of claim 15, wherein the method further comprises:
entering a text selection mode upon release of contact with the touch-sensitive screen.

17. The method of claim 16, wherein while in said text selection mode, said sliding causes movement of the cursor from a cursor start position to a cursor end position and any characters between the cursor start position and the cursor end position are identified.

18. The method of claim 1, wherein said identifying characters based at least in part on the detected finger tapping gesture includes:
generating metadata associated with said portion of text associated with said detected finger tapping gesture.

19. The method of claim 1, wherein said performing the further processing based at least in part on the identified characters includes interpreting the identified characters based on their formatting.

20. The method of claim 1, wherein said performing the further processing based at least in part on the identified characters includes:
recognizing said identified characters; and
populating a field using said identified and recognized characters.

21. The method of claim 20, wherein said populating the field using said identified and recognized characters includes populating a field of a user interface.

22. The method of claim 1, wherein said performing the further processing based at least in part on the identified characters includes:
populating a field using metadata associated with said identified characters.

23. A device for facilitating identification of characters based upon a gesture to a touch sensitive display, the device comprising:
a processor;
the touch sensitive display coupled to the processor; and
a memory coupled to the processor, wherein the memory is capable of storing instructions which when executed cause the device to perform a method, the instructions comprising:
acquiring an image that includes an unrecognized character string;
performing by the processor a recognition function on the image that includes the unrecognized character string;
displaying a representation of said image that includes the unrecognized character string on the touch sensitive display;
detecting a tapping gesture adjacent or on a region of the representation of said image on or near a region that includes said character string;
selecting characters of said character string based on said tapping gesture; and
performing a further processing based on the selected characters of said character string.

24. The device of claim 23, wherein performing said recognition function includes recognizing all characters of the unrecognized character string.

25. The device of claim 23, wherein performing said recognition function includes recognizing all unrecognized text of the image.

26. A computer-readable medium having stored thereon instructions, which when executed by a processing system, cause the processing system to perform a method for interacting with text in an image, comprising:
accessing an image;
determining whether said image includes unrecognized text;
when said image includes unrecognized text, performing by the processing system an identification function on at least some of the unrecognized text of the image;
displaying a representation of at least a portion of the image on a touch-enabled portion of said processing system;
detecting a touch gesture on said touch-enabled portion of said processing system;
identifying a portion of text based at least in part on the touch gesture; and
performing by the processing system a further processing of the identified portion of text in response to the touch gesture.

27. The computer-readable medium of claim 26, wherein parts of said identified portion of text are collinear.

28. The computer-readable medium of claim 26, wherein said accessing the image includes accessing an image captured by processing system operating in a video capture mode.

29. The computer-readable medium of claim 26, wherein said accessing the image includes accessing an image that is stored in a persistent medium.
